(19) United States
(12) Patent Application Publication
(10) Pub. No.: US 2003/0103015 A1
(43) Pub. Date: Jun. 5, 2003

(54) Skeleton slot radiation element and multi-band patch antenna using the same

(76) Inventors: Jeong-Kun Oh, Shiheung-Shi (KR); Yong-Hee Lee, Puchun-Shi (KR); Byung-Il Oh, Nam-Ku (KR); Woon-Phil Kim, Namdong-Ku (KR)

Correspondence Address: HARNESS, DICKEY & PIERCE, P.L.C., P.O. BOX 828, BLOOMFIELD HILLS, MI, 48303, US

(21) Appl. No.: 10/107,984

(22) Filed: Mar. 28, 2002

(30) Foreign Application Priority Data
Dec. 4, 2001 (KR) 2001-76366

(51) Int. Cl. H01Q 21/00; H01Q 1/38

(52) U.S. Cl. 343/867; 343/742; 343/700 MS

(57) ABSTRACT

A multi-band patch antenna includes a feeding unit for feeding signals, a skeleton slot radiation element for radiating radio waves, wherein the skeleton slot radiation element includes a feeding point connected to the feeding unit, first conductive loops symmetrically formed with the feeding point in the center and second conductive loops formed at the both sides of the first loops, and a reflector for reflecting backward radiation waves of the skeleton slot radiation element.

### FIELD OF THE INVENTION

The present invention relates to a multi-band patch antenna for transmitting and receiving radio waves at a base station of a wireless communication system; and, more particularly, to a multi-band patch antenna using an improved skeleton slot radiation element.

### BACKGROUND OF THE INVENTION

Generally, a dipole radiation element or a partially transformed dipole radiation element has been used as a radiation element of a conventional antenna in mobile communication base stations. FIG. 1 is a perspective view showing a conventional dipole array directional antenna. Four dipole elements 15, which are made of a metal material, are disposed in a 2×2 array on a reflector 11 for embodying a horizontal beamwidth of about 65 degrees.

Referring to FIG. 1, the conventional dipole array directional antenna includes the reflector 11, choke reflectors 12, a feeding cable 13 and a power divider 14. Signals inputted from the feeding cable 13 are divided to each dipole element 15 through the power divider 14. Also, the choke reflectors 12 located on both sides of the reflector 11 in a longitudinal direction has an effect on suppression of side lobes in the antenna by suppressing undesired radiation to both sides of the antenna.

However, these dipole elements for radiation have a narrow bandwidth of below 10%. When the dipole elements are used in the directional antenna, variation of beamwidth becomes larger according to a frequency and a characteristic of a voltage standing wave ratio (VSWR), which represents an antenna matching state, considerably goes bad at frequency bands except a used frequency band. Also, a gain of the antenna is decreased.

Generally, in a conventional mobile communication service, when a bandwidth of a cellular mobile system is 70 MHz and a central frequency is 859 MHz, a ratio of the bandwidth to the central frequency (hereinafter, referred to as a bandwidth ratio) is 8.15% ((70/859) □100), and when a bandwidth of a personal communication service (PCS) is 120 MHz, the bandwidth ratio is 6.63% ((120/1810)□100). Therefore, since the frequency band used in the conventional mobile communication service is not wideband as mentioned in the above, it is possible to use the conventional dipole structure in the cellular mobile system and the personal communication service even if such a conventional dipole structure is applied to a radiation element. However, since a frequency band, i.e., 1920 to 2170 MHz corresponding to a bandwidth ratio of 12.23% ((250/2045)□100), of a next-generation mobile communication or a dual band, i.e., 1750 to 2170 MHz corresponding to a bandwidth ratio of 21.4% ((420/1960)□100) of a personal communication service and next-generation mobile communication are wide, when the conventional dipole structure is applied thereto, it is impossible to obtain a desired VWSR, a beamwidth variation in its band frequency and a gain variation because of the bandwidth limitation of the conventional dipole structure.

As mentioned above, since the conventional antenna for a mobile communication is designed to provide services in a single frequency band, when the conventional antenna is employed as an antenna of the base station as it is, there is a demerit that many kinds of antennas have to be employed for providing services requiring various frequency bands, such as the cellular mobile communication, the personal communication service, the next-generation mobile communication or the like.

Furthermore, there are tendencies that an opinion, of which antennas installed in the base station are out of harmony with the surrounding environment, is raised and base stations are shared with other service companies to reduce a social cost. Therefore, it is not preferable for aspects of the cost and the surrounding environment to install a separate antenna for a frequency band corresponding to each service so that there is required to develop a multi-band antenna capable of being operated in various frequency bands.

In order to develop a multi-band antenna, a structure of a skeleton slot radiation element has been suggested. Generally, the skeleton slot radiation element is formed by a planar conductor having two slots which are formed by removing a center portion of the planar conductor. The shape of the slot in the planar conductor can be acceptable when an edge of the planar conductor is in a ring type based on the formation of the slot. With the shortened planar conductor based on the formation of the slot, a loop-type radiation element acts as a radiation element and has a low Q, so that it is possible to obtain a wide bandwidth. Also, since one skeleton slot radiation element has the same effect with two dipole radiation elements, a structure of the antenna may be simplified and, also, it may be easy to implement a wideband antenna with a high gain.

FIG. 2 is a perspective view showing a basic skeleton slot radiation element.

Referring to FIG. 2, a width of a horizontal side W is about ½ λ, λ being a wavelength of a used frequency, and a length of a vertical side L is about ¼ λ. That is, the skeleton slot radiation element is a shape of which feeding portions of two 1 λ loop radiation elements are coupled to each other. One feeding line of the skeleton slot radiation element is connected to ground of a reflector and the other feeding line is connected to a microstrip line by using a broadside coupled strip line.

FIG. 3 is a graph showing a return loss of the basic skeleton slot radiation element according to various frequencies.

Referring to FIG. 3, the graph shows two cases of return loss according to various frequencies. In the structure illustrated in FIG. 2, the first case is that a height from a reflector to the skeleton slot radiation element is 70 mm and the second case is that a height from a reflector to the skeleton slot radiation element is 33 mm. When the height of the skeleton slot radiation element is low, i.e., 33 mm from the reflector, the antenna has a narrow bandwidth at low frequencies and a wide bandwidth at high frequencies. On the other hand, when the height of the skeleton slot radiation element is highly set, for example, 70 mm away from the reflector, a wide bandwidth is shown at low frequencies and a characteristic of return loss is deteriorated at high frequencies.

The surface current distribution of a surface of the basic skeleton slot radiation element is similar to that of a loop radiation element. For example, in case of a frequency of 900 MHz, current is dominantly distributed at left and right sides of the skeleton slot radiation element and the current is weak at upper and lower sides thereof. In case of a frequency of 1800 MHz, current is dominantly distributed at the center of the skeleton slot radiation element.

FIG. 4 is a graph showing a horizontal radiation pattern on an X-Z plane for each frequency band of the basic skeleton slot radiation element.

Table 1 shows a horizontal beamwidth and a gain for each frequency band of the basic skeleton slot radiation element.

TABLE 1

| Frequency (GHz) | 0.8 | 0.9 | 1 | 1.1 | 1.2 | 1.3 | 1.4 | 1.5 | 1.6 | 1.7 | 1.8 | 1.9 | 2.0 |
|---|---|---|---|---|---|---|---|---|---|---|---|---|---|
| Horizontal | 70.9 | 68.0 | 65.4 | 62.9 | 61.1 | 61.5 | 55.5 | 48.6 | 43.0 | 38.8 | 145.6 | 139.3 | 121.3 |
| Beamwidth (°) | | | | | | | | | | | | | |
| Gain (dBi) | 8.8 | 9.0 | 9.2 | 9.4 | 9.6 | 8.7 | 9.6 | 8.5 | 8.1 | 9.3 | 6.5 | 6.6 | 7.1 |

Referring to Table 1, the horizontal beamwidth of the basic skeleton slot is maintained in 70°±5° at a frequency band of 900 MHz. However, in a frequency band of 1.8 GHz, current distribution becomes disordered and a radiation pattern is irregularly changed according to frequencies. Namely, there is a problem that the horizontal beamwidth becomes gradually narrower from 800 MHz to 1.7 GHz and then becomes suddenly wider from 1.8 GHz.

Also, a desired return loss characteristic is not expected at a high frequency band for the basic skeleton slot radiation element, so that a structure of the skeleton slot radiation element should be modified to improve an antenna characteristic.

In addition, when the beamwidth ratio is over 50%, an impedance characteristic is deteriorated and a radiation pattern is suddenly changed. Therefore, a bandwidth spreading technology is required.

Since frequency bands currently served to the mobile communication system are of 800 MHz to 960 MHz and 1700 MHz to 1900 MHz and a frequency band in the next-generation mobile communication service will be 1920 MHz to 2170 MHz, the difference between the highest frequency band and the lowest frequency becomes over twice, so that, if the basic skeleton slot radiation element is used, it is hard to obtain a desired radiation pattern.

### SUMMARY OF THE INVENTION

It is, therefore, an object of the present invention to provide a multi-band patch antenna using an improved skeleton slot radiation element to improve an impedance characteristic by using supplementary slots to stabilize a radiation pattern for multiple frequency bands.

In accordance with an aspect of the present invention, there is provided a multi-band patch antenna, comprising: a feeding means for feeding signals; a skeleton slot radiation means for radiating radio waves, wherein the skeleton slot radiation means includes: a feeding point connected to the feeding means; first conductive loops symmetrically formed with the feeding point in the center; and second conductive loops formed at the both sides of the first conductive loops; and a reflecting means for reflecting backward radiation waves of the skeleton slot radiation means.

In accordance with another aspect of the present invention, there is provided a skeleton slot radiation element for radiating radio waves having multiple bands, comprising: a feeding point formed in the center of the skeleton slot radiation element; first conductive loops symmetrically formed with the feeding point in the center; and second conductive loops formed at the both sides of the first conductive loops.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects and features of the instant invention will become apparent from the following description of preferred embodiments taken in conjunction with the accompanying drawings, in which:

FIG. 1 is a perspective view showing a conventional dipole array directional antenna;

FIG. 2 is a perspective view showing a basic skeleton slot radiation element;

FIG. 3 is a graph showing a reflection loss of the basic skeleton slot radiation element according to frequencies;

FIG. 4 is a graph showing a horizontal radiation pattern of an X-Z plane for each frequency band according to the basic skeleton slot radiation element;

FIG. 5 is a perspective view showing an antenna using a skeleton slot radiation element in accordance with the present invention;

FIG. 6 is an exploded perspective view showing the antenna in FIG. 5 in accordance with the present invention;

FIG. 7 is a top view showing a skeleton slot radiation element of a multi-band patch antenna in accordance with the present invention;

FIG. 8 is a magnified top view of the current dividing portion 82 in FIG. 7;

FIG. 9 is a magnified top view of the feeding portion 83 in FIG. 7;

FIG. 10 is a magnified top view magnifying the bent corner 84 in FIG. 7;

FIG. 11 is a graph showing a return loss characteristic when a dual band of 900 MHz and 1800 MHz is applied to the improved skeleton slot radiation element; and

FIG. 12 is graph showing a horizontal radiation pattern of the skeleton slot radiation element in accordance with the present invention.

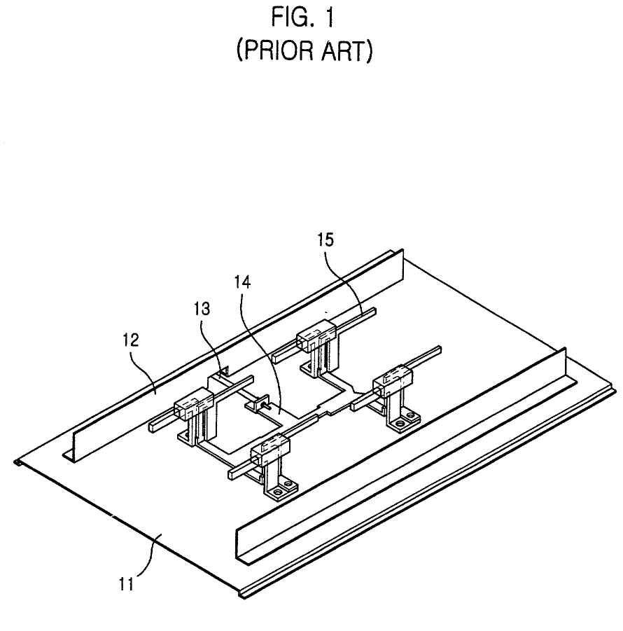

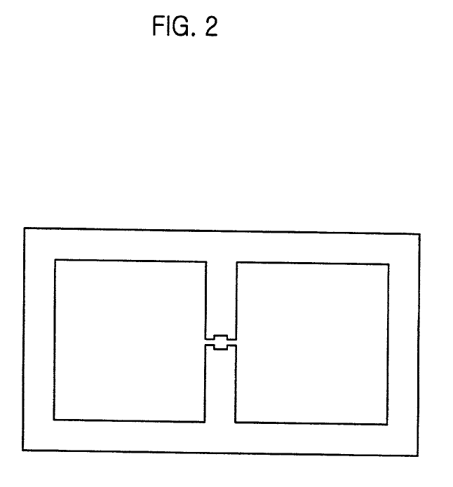

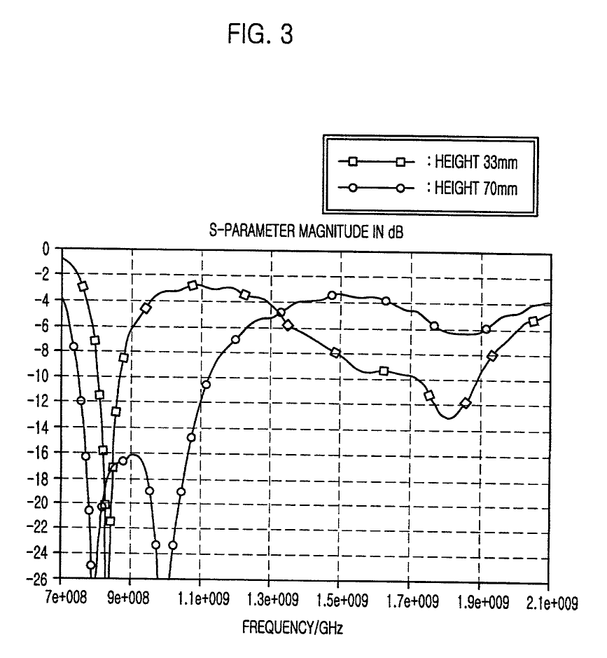

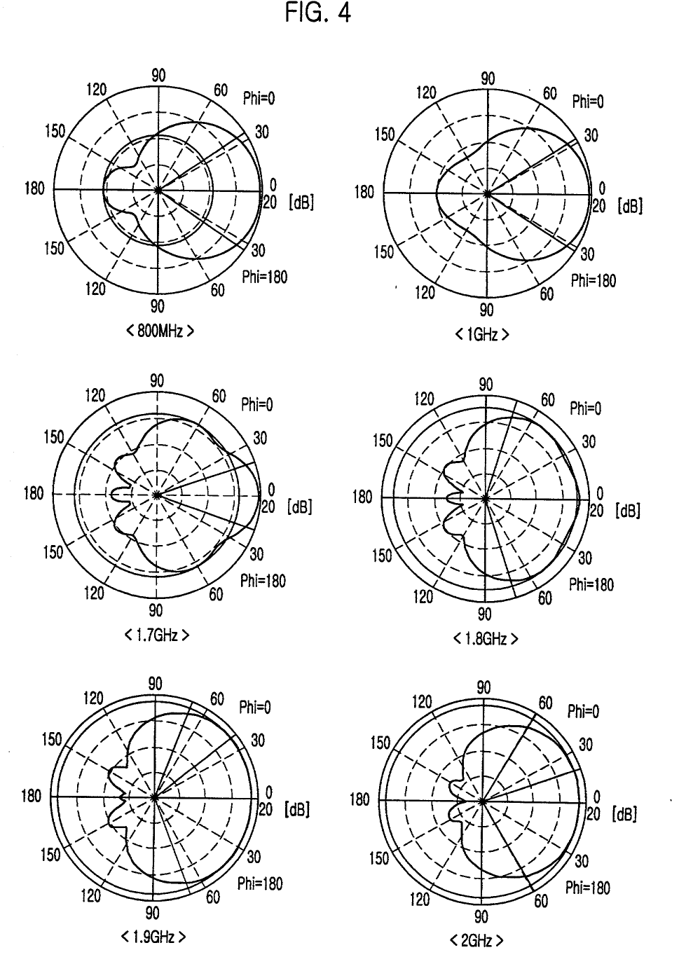

### DETAILED DESCRIPTION OF THE PREFERRED EMBODIMENTS

The following description of the preferred embodiment(s) is merely exemplary in nature and is in no way intended to limit the invention, its application, or uses.

Hereinafter, a skeleton slot radiation element and an antenna using the same to be used at wide bandwidth in accordance with the present invention will be described in detail with reference to the accompanying drawings.

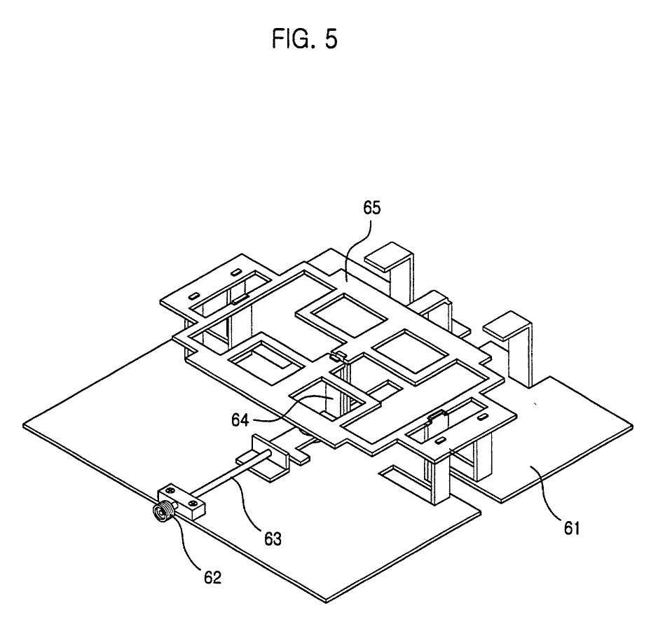

FIG. 5 is a perspective view showing an antenna using a skeleton slot radiation element in accordance with the present invention.

Generally, transmitting and receiving operations of an antenna are performed in the same manner. Namely, since a reciprocal principle can be applied to the antenna operation, the transmitting operation of the antenna will be only described.

Referring to FIG. 5, a transmission signal inputted to a connector 62 is supplied to a radiation element 65 by a vertical feeding unit 64, which is located in the center of a reflector 61, via a feeding cable 63.

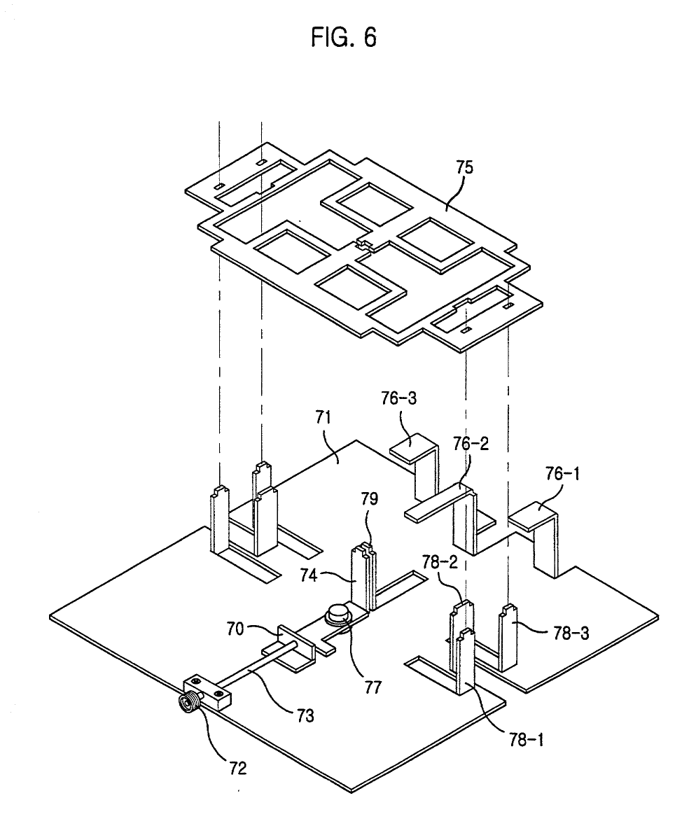

FIG. 6 is an exploded perspective view showing the antenna in FIG. 5 in accordance with the present invention.

Referring to FIG. 6, the multi-band patch antenna in accordance with the present invention includes a skeleton slot radiation element 75 and a reflector 71. A feeding point is formed in the center of the skeleton slot radiation element 75. A plurality of slots are symmetrically formed with the feeding point as a center. A connector 72 is formed at a center of an edge side of the reflector 71.

A signal inputted to the connector 72 is fed into the feeding cable 73 and the signal is provided to the skeleton slot radiation element 75 through a vertical feeding unit 74 and a vertical ground unit 79, which are formed at a central portion of the reflector 71.

The vertical feeding unit 74 is connected to the feeding cable 73 so as to transmit the signal to the radiation element 75 and the vertical ground unit 79 is connected to the reflector 71. The vertical ground unit 79 acts as ground of the skeleton slot radiation element 75.

The reflector 71 reflects undesired signals and a plurality of elements configured for the multi-band patch antenna are formed on the reflector 71. First to third short pins 78-1, 78-2 and 78-3, which are coupled to portions in which current relatively and dominantly flows in the skeleton slot radiation element 71, are symmetrically formed at both sides of the reflector 71 with the vertical feeding unit 74 as a center in order to uniformly maintain a radiation pattern in a high frequency band by stabilizing the current distribution of the skeleton slot radiation element 75. At this time, fine tuning of impedance and radiation pattern of the antenna can be performed by using the short pins 78-1, 78-2 and 78-3.

First to third coupling units 76-1, 76-2 and 76-3 are formed at an opposite site of the connector 72 with a predetermined distance away from the skeleton slot radiation element 75. The first and third coupling units 76-1 and 76-3 are to improve an impedance characteristic at a low frequency band, e.g., 850 MHz, and the second coupling unit 76-2 is to improve impedance at overall frequency bands.

Hereinafter, there will be described operations of the first to third short pins 78-1, 78-2, 78-3 and the first to third coupling units 76-1, 76-2, 76-3.

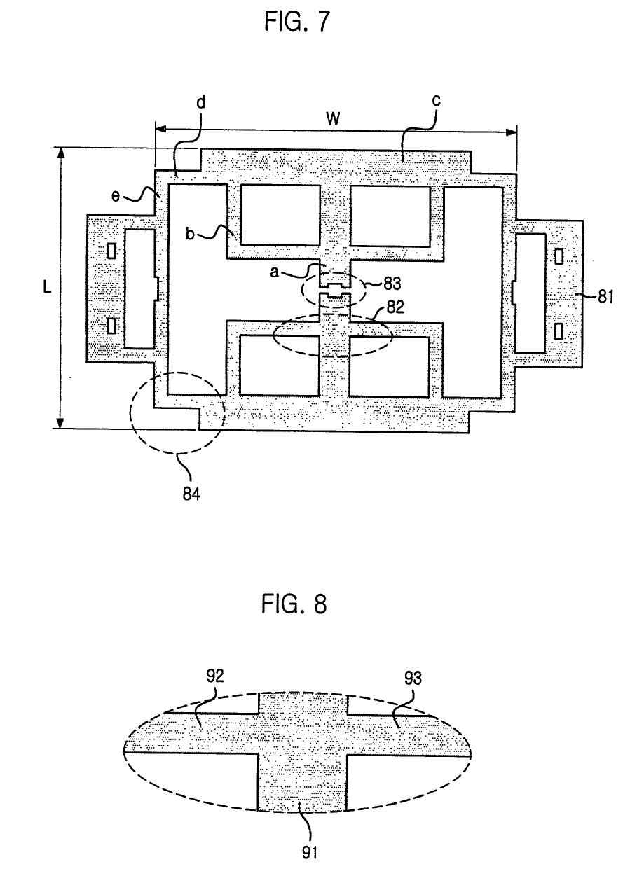

The first to third short pins 78-1, 78-2 and 78-3 and the first to third coupling units 76-1, 76-2 and 76-3 are formed by cutting and bending predetermined portions of the reflector 71. The first to third short pins 78-1, 78-2 and 78-3 are connected to outside loops 81 of a square bracket shape based on formation of supplementary slots to be described in FIG. 7. The first and third short pins 78-1 and 78-3 is to uniformly maintain a radiation pattern at a high frequency band, i.e., over 1.9 GHz, and the second short pin 78-2 is to uniformly maintain a radiation pattern and to improve an impedance characteristic at a high frequency, i.e., over 1.7 GHz.

The first to third coupling units 76-1, 76-2 and 76-3 are formed at a predetermined distance away from the skeleton slot radiation element 75. The first and third coupling units 76-1 and 76-3 are formed adjacent to both sides of an edge of the skeleton slot radiation element 75 to improve an impedance characteristic at a low frequency band, i.e., below 850 MHz. The second coupling unit 76-2, which is longer than the first and third coupling units 76-1 and 76-3 toward the feeding point, is formed adjacent to the central portion of the skeleton slot radiation element 75 to totally improve an impedance characteristic of the antenna.

Accordingly, since a desired voltage standing wave ratio of the antenna can be acquired in a low frequency band of 850 MHZ without using the coupling units, the coupling units are not essential structural elements of the antenna in accordance with the present invention. Namely, the coupling units are additionally employed to improve a voltage standing wave ratio at a low frequency band of below 850 MHz.

Since the vertical ground unit 79, the first to third short pins 78-1,78-2, and 78-3, the first to third coupling units 76-1, 76-2 and 76-3 and a cable support 70 are formed by cutting and bending some portions of the reflector 71, a structure and a fabricating process of the multi-band patch antenna may be simplified and a cost may be reduced.

A spacer 77 is formed with a dielectric material to make the vertical feeding unit 74 a predetermined distance away from the reflector 71.

Hereinafter, the skeleton slot radiation element improved in accordance with the present invention will be described.

Generally, a basic structure of the skeleton slot radiation element is formed to have a width W of about ½ λ, λ being a wavelength, and a length L of about ¼ λ. The radiation of radio wave occurs at both edges of the skeleton slot radiation element, which have a length of about ¼ λ. If the highest frequency becomes twice as high as the lowest frequency, a length W becomes over one wavelength of the highest frequency, so that distortion of a radiation pattern is caused.

To solve the above problem, the present invention does not use only inside loops based on the basic skeleton slot radiation element, but use outside loops of a square bracket shape ([ ]) based on formation of supplementary slots additionally formed at both edges of the basic skeleton slot radiation element, so that current is divided into the inside loop and the outside loop. When a low frequency is used, the current flows into the outside and inside loops. When a high frequency is used, the current dominantly flows to the inside loop, so that even if a high frequency of over twice as high as the lowest frequency is used, a radiation pattern can be uniformly maintained.

FIG. 7 is a top view showing the skeleton slot radiation element of the multi-band patch antenna in accordance with the present invention.

Referring to FIG. 7, a basic shape of the skeleton slot radiation element is formed to ½ λ of the lowest resonant frequency and a length L of ¼ λ, λ being a wavelength of the lowest frequency. However, the present invention employs the additional outside loops 81 formed at both edges of the skeleton slot radiation element, through which radio waves are practically radiated, in order to divide the current flowing through the skeleton slot radiation element.

As the current flowing through the skeleton slot radiation element 75 is divided into the inside and outside loops by forming the supplementary slots at both edges, when a low frequency is used, the current flows into the outside and inside loops, and, when a high frequency is used, the current dominantly flows to the inside loop.

The skeleton slot radiation element includes a feeding portion 83 connected to the vertical feeding unit 74 and the vertical ground unit 79, current dividing portions 82, which are formed by additionally employing feeding lines connecting a central feeding line to other feeding lines forming a loop of the skeleton slot radiation element, and bent corners 84. The current fed to the feeding portion 83 is tri-directionally divided at the current dividing portion 82.

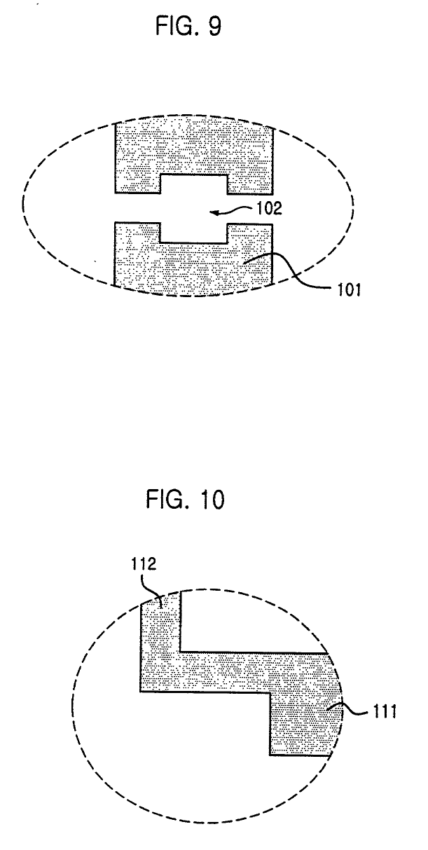

FIGS. 8 to 10 show magnified top view of the current dividing portion 82, the feeding portion 83 and the bent corner 84 in FIG. 7, respectively.

Referring to FIGS. 7 to 10, the width of a feeding line 101 connected to the vertical feeding unit 74 is relatively wider than other lines and widths of tree-feeding lines 91, 92 and 93 divided in the current dividing portion 82 are different. For example, when considering a wavelength A of a low frequency, i.e., 850 MHz, the feeding line 91 connected to the vertical feeding unit 74 is formed to a width of 0.05 λ to 0.07 λ. The feeding line 91 is formed to a width of 0.057 λ in accordance with a preferred embodiment of the present invention. Also, the feeding line b in FIG. 7 is formed to a width of 0.01 λ to 0.02 λ. The feeding lines 92 and 93 are formed to a width of 0.0125 λ in accordance with a preferred embodiment of the present invention.

The feeding lines of the skeleton slot radiation element in accordance with the present invention are formed to have different widths. Specially, the bent corner 84 is bent in multiple steps and widths of a vertical feeding line 112 and a width of a horizontal feeding line 111 are different. For example, when considering a wavelength λ of a low frequency, i.e., 850 MHz, upper and lower slot lines c are formed to a width of 0.03 λ to 0.05 λ and are formed to 0.04 λ in accordance with a preferred embodiment of the present invention. A horizontal portion d of a corner of the bent corner 84 is formed to a width of 0.01 λ to 0.03 λ and is formed to 0.015 λ in accordance with a preferred embodiment of the present invention. A vertical portion e of the bent corner 84 is formed to a width of 0.01 λ to 0.03 λ and is formed to 0.0125 λ in accordance with a preferred embodiment of the present invention.

Hereinafter, for example, there will be described the improved skeleton slot radiation element applied to a dual band of 900 MHz and 1800 MHz.

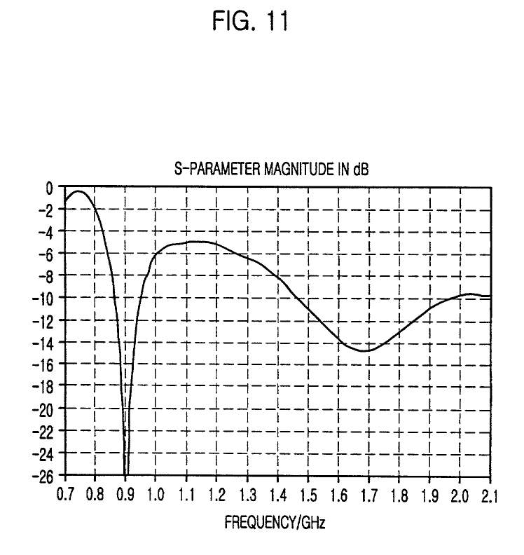

FIG. 11 is a graph showing a return loss characteristic when the improved skeleton slot radiation element is applied to the dual band of 900 MHz and 1800 MHz. The graph shows a dual resonance and a wideband resonance characteristic.

When the skeleton slot radiation element in accordance with the present invention is applied to the dual band of 900 MHz and 1800 MHz, current fed from the feeding point is tri-directionally distributed at the current dividing portion 82 in FIG. 7. In the relatively low frequency of 900 MHz, current is divided into the inside and outside loops in the skeleton slot radiation element in accordance with the present invention and, in the relatively high frequency of 1800 MHz, the current dominantly flows at the inside loops.

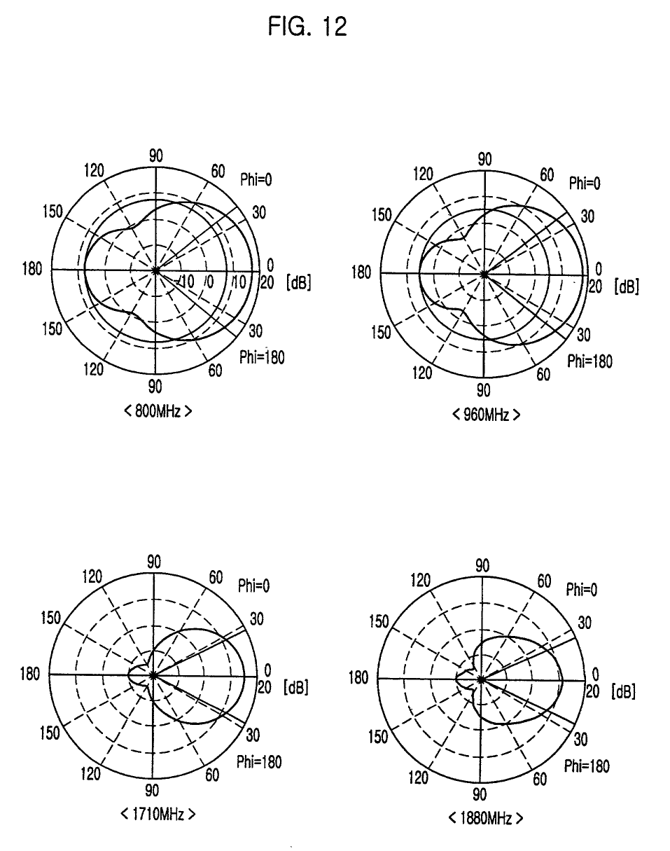

FIG. 12 is graph showing a horizontal radiation pattern of the skeleton slot radiation element in accordance with the present invention.

When a difference between the highest frequency and the lowest frequency becomes twice, a length of a loop corresponding to a ½ wavelength of the lowest frequency becomes approximately one wavelength of the highest frequency. When a high frequency is applied to the skeleton slot radiation element, current dominantly flows at an inside loop formed by a basic slot, so that it has an effect that a length of a loop is reduced below one wavelength of the high frequency.

Since the current is tri-directionally divided at the current dividing portion 82, a desired radiation pattern can be uniformly maintained even if the high frequency is applied.

Table 2 shows a horizontal beamwidth and a gain for each frequency band of the improved skeleton slot radiation element.

TABLE 2

| Frequency | | | | | | | | | | | | | |
|---|---|---|---|---|---|---|---|---|---|---|---|---|---|
| (GHz) | 0.8 | 0.9 | 1 | 1.1 | 1.2 | 1.3 | 1.4 | 1.5 | 1.6 | 1.7 | 1.8 | 1.9 | 2.0 |
| Horizontal | 77.3 | 74.3 | 72.3 | 70.1 | 67.5 | 64.9 | 63.1 | 61.0 | 55.3 | 54.9 | 52.1 | 50.3 | 50.9 |
| Beamwidth (°) | | | | | | | | | | | | | |
| Gain (dBi) | 7.0 | 8.1 | 8.4 | 8.6 | 8.9 | 9.2 | 9.4 | 9.8 | 10.6 | 10.6 | 10.8 | 10.8 | 10.5 |

Accordingly, when the improved skeleton slot radiation element is applied to a single band of a next-generation mobile communication and multiple bands of cellular mobile communication, personal communication service and the like, the improved skeleton slot radiation element can obtain a uniform radiation characteristic and be resonated in the wide bands, so that a high service quality of the wideband mobile communication system can be acquired.

When the skeleton slot radiation element in accordance with the present invention is applied to the conventional base station, since only the radiation element is replaced for any services, it has an effect that a cost is reduced.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A multi-band patch antenna, comprising:
a feeding means for feeding signals;
a skeleton slot radiation means for radiating radio waves, wherein the skeleton slot radiation means includes:
a feeding point connected to the feeding means;
first conductive loops symmetrically formed with the feeding point in the center; and
second conductive loops formed at the both sides of the first conductive loops; and
a reflecting means for reflecting backward radiation waves of the skeleton slot radiation means.

2. The multi-band patch antenna as recited in claim 1, further comprising:
a connector for connecting the antenna to other device and supplying signals to the antenna;
a feeding cable for transmitting the signals supplied from the connector to the feeding means; and
a short means for grounding the skeleton slot radiation means to the reflecting means in order to stabilize current distribution of the skeleton slot radiation means.

3. The multi-band patch antenna as recited in claim 2, wherein the skeleton slot radiation means further includes current dividing portions for dividing a current fed to the feeding point of the skeleton slot radiation means into a plurality of directions.

4. The multi-band patch antenna as recited in claim 3, wherein the current dividing portions are formed with conductive lines, a first conductive line being connected to the feeding point and second and third conductive lines being connected to the first conductive line.

5. The multi-band patch antenna as recited in claim 4, wherein widths of the first, second and third conductive lines are different to each other.

6. The multi-band patch antenna as recited in claim 1, wherein the first conductive loops are formed in a square shape, corners of the first conductive loops being bent in multiple steps and widths of vertical and horizontal portions of the corners being different.

7. The multi-band patch antenna as recited in claim 1, wherein the second conductive loops are formed by sharing a portion of the first conductive loops and in a square bracket shape.

8. The multi-band patch antenna as recited in claim 1, wherein widths of each portion of the first and second conductive loops are different to each other.

9. The multi-band patch antenna as recited in claim 2, further comprising a coupling means on the reflecting means to improve an impedance characteristic thereof.

10. The multi-band patch antenna as recited in claim 9, wherein the coupling means includes:
first and third coupling units formed on the reflecting means adjacent to both outsides of the skeleton slot radiation means; and
a second coupling unit, which is formed in the center of the reflecting means beneath the skeleton slot radiation means.

11. The multi-band patch antenna as recited in claim 2, wherein the feeding means includes:
a feeding unit for transmitting signals received from the feeding cable into the skeleton slot radiation means, wherein the feeding unit is vertically formed toward the skeleton slot radiation means in the center of the reflecting means; and
a ground unit vertically formed in the center of the reflecting means, parallel with the feeding unit, for grounding the skeleton slot radiation means to the reflecting means.

12. The multi-band patch antenna as recited in claim 11, wherein the ground unit and the short means are formed by cutting and bending the reflecting means.

13. The multi-band patch antenna as recited in claim 12, wherein the short means includes a plurality of shorting pins to improve an impedance characteristic and uniformly maintain a radiation pattern and the short means are formed at predetermined positions to ground parts of the skeleton slot radiation element to the reflecting means.

14. A skeleton slot radiation element for radiating radio waves having multiple bands, comprising:
a feeding point formed in the center of the skeleton slot radiation element;
first conductive loops symmetrically formed with the feeding point in the center; and
second conductive loops symmetrically formed at both sides of the first conductive loops.

15. The skeleton slot radiation element as recited in claim 14, wherein the first conductive loops are formed to a square shape.

16. The skeleton slot radiation element as recited in claim 15, wherein corners of the first conductive loops are bent in multiple steps and each vertical and horizontal portion of the corners is formed to have different widths.

17. The skeleton slot radiation element as recited in claim 14, wherein the second conductive loops are formed by sharing a portion of the first conductive loops and in a square bracket shape.

18. The skeleton slot radiation element as recited in claim 14, further comprising current dividing portions for dividing a current fed to the feeding point into a plurality of directions of the skeleton slot radiation means.

19. The skeleton slot radiation element as recited in claim 18, wherein the current dividing portions are formed with conductive lines, a first conductive line being connected to the feeding point and second and third conductive lines being connected to the first conductive line.

20. The skeleton slot radiation element as recited in claim 19, wherein widths of the first and second loops are different.
